(19) United States
(12) Patent Application Publication
(10) Pub. No.: US 2022/0097970 A1
(43) Pub. Date: Mar. 31, 2022

(54) DELIVERY VEHICLE, DELIVERY VEHICLE CONTROL SYSTEM, DELIVERY VEHICLE CONTROL METHOD, AND NON-TRANSITORY STORAGE MEDIUM

(71) Applicant: TOYOTA JIDOSHA KABUSHIKI KAISHA, Aichi-ken (JP)

(72) Inventor: Hiroaki KIYOKAMI, Nisshin-shi (JP)

(21) Appl. No.: 17/410,990

(22) Filed: Aug. 24, 2021

(30) Foreign Application Priority Data
Sep. 29, 2020 (JP) 2020-164008

(51) Int. Cl. B65G 1/137; B60P 1/44; G06Q 10/08; G06Q 50/28

(52) U.S. Cl. CPC B65G 1/137; B60P 1/4421; B65G 67/20; G06Q 10/083; G06Q 50/28; B60P 1/4442

(57) ABSTRACT

A delivery vehicle includes a vehicle body, an opening that is provided at the vehicle body, that is configured to be opened and closed by a shutter section, and that is configured to place a cabin interior and a cabin exterior in communication with each other, a housing area that is provided at the cabin interior and that is configured to house a package, a rail that is provided at the cabin interior, and a transfer unit that is configured to move along the rail and to transfer the package between the housing area and the opening.

### CROSS-REFERENCE TO RELATED APPLICATION

This application is based on and claims priority under 35 USC 119 from Japanese Patent Application No. 2020-164008 filed on Sep. 29, 2020, the disclosure of which is incorporated by reference herein.

### BACKGROUND

### Technical Field

The present disclosure relates to a delivery vehicle, a delivery vehicle control system, a delivery vehicle control method, and a non-transitory storage medium.

### Related Art

For example, Japanese Patent Application Laid-Open (JP-A) No. 2020-90151 discloses a delivery system in which a robot arm is used to house a package that has been loaded onto a conveyor provided inside a vehicle cabin in a housing compartment of a mobile robot.

In the delivery system disclosed in JP-A No. 2020-90151, the conveyor needs to be installed across the entirety of a package loading area inside the vehicle cabin. Due to the need to install such bulky equipment inside the vehicle, the package loading space might be limited as a result. A delivery vehicle that enables more packages to be loaded and has a simpler configuration is therefore desired.

The present disclosure provides a delivery vehicle configured to secure package loading space with a simpler configuration, and a delivery vehicle control system configured to improve operating efficiency in such a delivery vehicle.

A delivery vehicle of a first aspect includes a vehicle body, an opening that is provided at the vehicle body, that is configured to be opened and closed by a shutter section, and that places a cabin interior and a cabin exterior in communication with each other, a housing area that is provided at the cabin interior and that is configured to house a package, a rail that is provided at the cabin interior, and a transfer unit that is configured to move along the rail and to transfer the package between the housing area and the opening.

The delivery vehicle of the first aspect includes the rail provided at the cabin interior, and the transfer unit that is configured to move along the rail and to transfer the package between the housing area in which the package is housed and the opening placing the cabin interior and the cabin exterior in communication with each other.

This enables a package to be carried from the housing area toward the opening by the transfer unit moving along the rail. The package can thus be transported without employing bulky equipment such as a conveyor that requires motive force, thereby enabling a simpler configuration and more package loading space to be secured than in cases in which a conveyor is employed.

A delivery vehicle control system of a second aspect is a delivery vehicle control system for installation in the delivery vehicle of the first aspect. The delivery vehicle control system includes a vehicle interior sensor configured to detect a state of the cabin interior, an open/closed state detection section configured to detect an open/closed state of the shutter section, and a transfer control section configured to cause the transfer unit to perform a transfer operation for the package in a case in which the cabin interior has been detected to be free of any occupant by the vehicle interior sensor and the shutter section has been detected to be in a closed state by the open/closed state detection section.

In the delivery vehicle control system of the second aspect, the transfer unit is caused to perform the transfer operation for the package in a case in which the cabin interior has been detected to be free of occupants and the shutter section has been detected to be in the closed state. Thus, the transfer unit is only operated when no occupants are present in the cabin interior, thereby enabling occupant safety to be secured. Since there is no risk of the transfer unit coming into contact with an occupant or worker in the cabin interior, emergency stoppages and the like can be avoided during the transfer operation of the package, thereby enabling the operating efficiency of the transfer unit to be improved.

A delivery vehicle control system of a third aspect is a delivery vehicle control system for installation in the delivery vehicle of the first aspect. The delivery vehicle control system includes an open/closed state detection section configured to detect an open/closed state of the shutter section, and a transfer control section configured to cause the transfer unit to move to a retracted position separated from the opening in a case in which the shutter section has been detected to be in an open state by the open/closed state detection section.

In the delivery vehicle control system of the third aspect, the transfer unit is moved to the retracted position separated from the opening in a case in which the shutter section is in the open state, thereby enabling the transfer unit to be suppressed from getting in the way of a worker. This enables working space to be secured in the vicinity of the opening, enabling worker operating efficiency to be improved.

A delivery vehicle control system of a fourth aspect is the delivery vehicle control system of the second aspect, wherein the transfer control section is configured to cause the transfer unit to move to a retracted position separated from the opening in a case in which the shutter section has been detected to be in an open state by the open/closed state detection section.

In the delivery vehicle control system of the fourth aspect, the transfer unit is moved to the retracted position separated from the opening in a case in which the shutter section is in the open state, thereby enabling the transfer unit to be suppressed from getting in the way of a worker. This enables working space to be secured in the vicinity of the opening, enabling worker operating efficiency to be improved.

A delivery vehicle control system of a fifth aspect is the delivery vehicle control system of any one of the second aspect to the fourth aspect, further including a communication section that is configured to confirm cooperation readiness between the delivery vehicle and a moving body configured to move externally to the delivery vehicle and configured to transport the package. The transfer control section is configured to cause the transfer unit to perform a transfer operation for the package even when the shutter section has been detected to be in an open state by the open/closed state detection section in cases in which the cooperation readiness between the delivery vehicle and the moving body has been confirmed by the communication section.

In the delivery vehicle control system of the fifth aspect, the transfer unit is caused to perform the transfer operation for the package even when the shutter section has been detected to be in the open state in cases in which the cooperation readiness between the delivery vehicle and the moving body has been confirmed. This enables the package transfer operation to be performed by the transfer unit even when the shutter section is in the open state, as long as there is cooperation readiness between the delivery vehicle and the moving body. This enables the package transfer operation to be performed if required even when the shutter section is in the open state, such that operating efficiency is improved.

A delivery vehicle control system of a sixth aspect is the delivery vehicle control system of the fifth aspect, further including an object detection section configured to detect whether or not an object is present within a predetermined peripheral range of the moving body. The transfer control section is configured to control such that transfer of the package is not performed by the transfer unit in a case in which the presence of an object has been detected within the predetermined peripheral range of the moving body by the object detection section.

In the delivery vehicle control system of the sixth aspect, control is performed such that transfer of the package is not performed by the transfer unit in a case in which the presence of an object has been detected within the predetermined peripheral range of the moving body. This enables the safety of occupants, workers, and the like to be secured.

A delivery vehicle control system of a seventh aspect is the delivery vehicle control system of any one of the second aspect to the sixth aspect, wherein the opening is a ceiling opening provided at a vehicle roof section, and the shutter section is a ceiling shutter provided at the ceiling opening. Moreover, the delivery vehicle control system further includes an opening/closing control section configured to permit an opening/closing operation of the ceiling shutter in a case in which a parking position has been selected as a shift range of a shift lever of the delivery vehicle.

In the delivery vehicle control system of the seventh aspect, the opening/closing operation of the ceiling shutter is permitted in cases in which the parking position has been selected as the shift range of the shift lever of the delivery vehicle. This enables opening and closing of the ceiling shutter to be prevented while the delivery vehicle is in motion.

A delivery vehicle control system of an eighth aspect is the delivery vehicle control system of the seventh aspect, further including a shift control section configured to prevent selection of a shift position other than the parking position as the shift range of the shift lever while an opening/closing operation of the ceiling shutter is in progress.

In the delivery vehicle control system of the eighth aspect, selection of a shift position other than the parking position as the shift range of the shift lever is prevented while an opening/closing operation of the ceiling shutter is in progress. This enables the delivery vehicle to be prevented from moving while an opening/closing operation of the ceiling shutter is in progress.

As described above, the delivery vehicle of the first aspect is configured to secure more package loading space with a simpler configuration than in cases in which a conveyor requiring motive force is employed.

In the delivery vehicle control system of the second aspect, there is no risk of the transfer unit coming into contact with an occupant or worker in the cabin interior, enabling emergency stoppages and the like to be avoided during the package transfer operation, thereby improving the operating efficiency of the transfer unit.

The delivery vehicle control system of the third aspect is configured to secure working space in the vicinity of the opening, thereby improving worker operating efficiency.

The delivery vehicle control system of the fourth aspect enables working space to be secured in the vicinity of the opening, thereby improving worker operating efficiency.

The delivery vehicle control system of the fifth aspect enables the package transfer operation to be performed if required even when the shutter section is in the open state, thereby improving operating efficiency.

The delivery vehicle control system of the sixth aspect enables the safety of occupants, workers, and the like to be secured.

The delivery vehicle control system of the seventh aspect enables opening and closing of the ceiling shutter to be prevented while the delivery vehicle is in motion.

The delivery vehicle control system of the eighth aspect enables the delivery vehicle to be prevented from moving while an opening/closing operation of the ceiling shutter is in progress.

### BRIEF DESCRIPTION OF THE DRAWINGS

Exemplary embodiments of the present invention will be described in detail based on the following figures, wherein:

FIG. 1 is a perspective view illustrating a vehicle according to a first exemplary embodiment as viewed from a front left side, with a left side of the vehicle partially cut away;

FIG. 2 is a perspective view illustrating a vehicle according to the first exemplary embodiment as viewed from an upper left side, with an upper side of the vehicle partially cut away;

FIG. 3 is a plan view of a vehicle according to the first exemplary embodiment with an upper side of the vehicle partially cut away;

FIG. 4 is an enlarged perspective view illustrating part of a cabin interior of a vehicle according to the first exemplary embodiment;

FIG. 5 is a perspective view illustrating an example of an unloading mechanism of a vehicle according to the first exemplary embodiment, with an upper side of the vehicle partially cut away;

FIG. 6 is a block diagram illustrating a hardware configuration of a vehicle control system installed in vehicle according to the first exemplary embodiment;

FIG. 7 is a block diagram illustrating an example of functional configuration of a CPU of a control device of a vehicle;

FIG. 8 is a flowchart illustrating an example of a flow of processing in a transfer operation performed by a vehicle control system;

FIG. 9 is a flowchart illustrating an example of a flow processing in a package transfer operation;

FIG. 10 is a perspective view of a vehicle according to the first exemplary embodiment with an upper side of the vehicle partially cut away, in order to explain an example of a retraction operation;

FIG. 11 is a side view illustrating a vehicle control system according to a second exemplary embodiment;

FIG. 12 is a block diagram illustrating a hardware configuration of a vehicle control system according to the second exemplary embodiment;

FIG. 13 is a block diagram illustrating an example of functional configuration of a CPU of a control device of a vehicle control system according to the second exemplary embodiment;

FIG. 14 is a flowchart (1 of 2) illustrating an example of a flow of transfer operation processing performed by a vehicle control system according to the second exemplary embodiment;

FIG. 15 is a flowchart (2 of 2) illustrating an example of a flow of transfer operation processing performed by a vehicle control system according to the second exemplary embodiment;

FIG. 16 is a block diagram illustrating an example of functional configuration of a CPU in a control device of a vehicle control system according to a third exemplary embodiment; and

FIG. 17 is a flowchart illustrating an example of a flow of transfer operation processing performed by a vehicle control system according to the third exemplary embodiment.

### DETAILED DESCRIPTION

### First Exemplary Embodiment

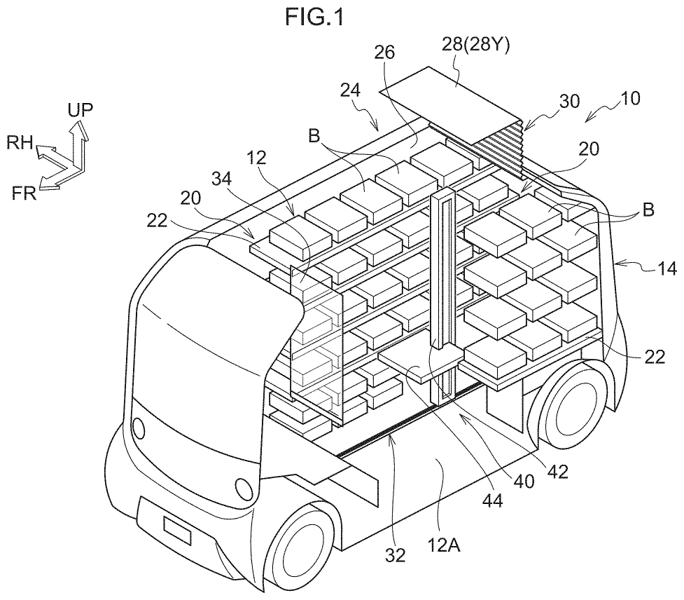

Explanation follows regarding a vehicle 10 according to a first exemplary embodiment of the present disclosure, with reference to FIG. 1 to FIG. 3. Note that in the drawings, the arrow FR indicates a vehicle front side, the arrow UP indicates a vehicle upper side, and the arrow RH indicates a vehicle width direction right side.

Vehicle

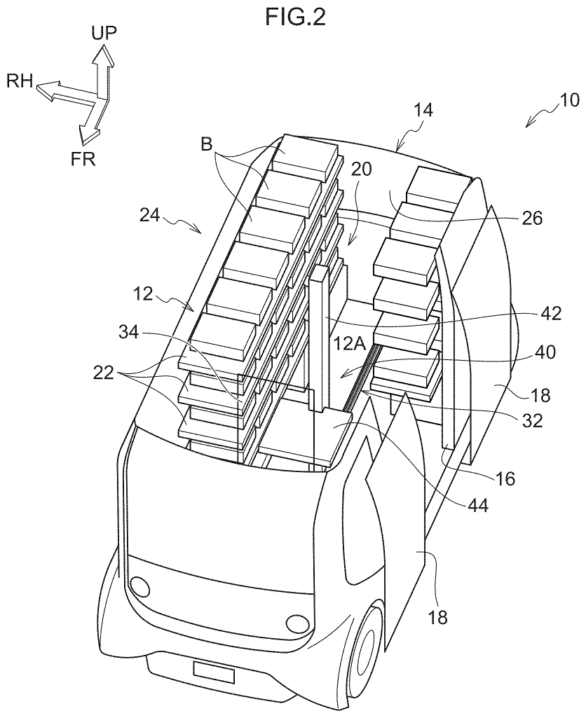

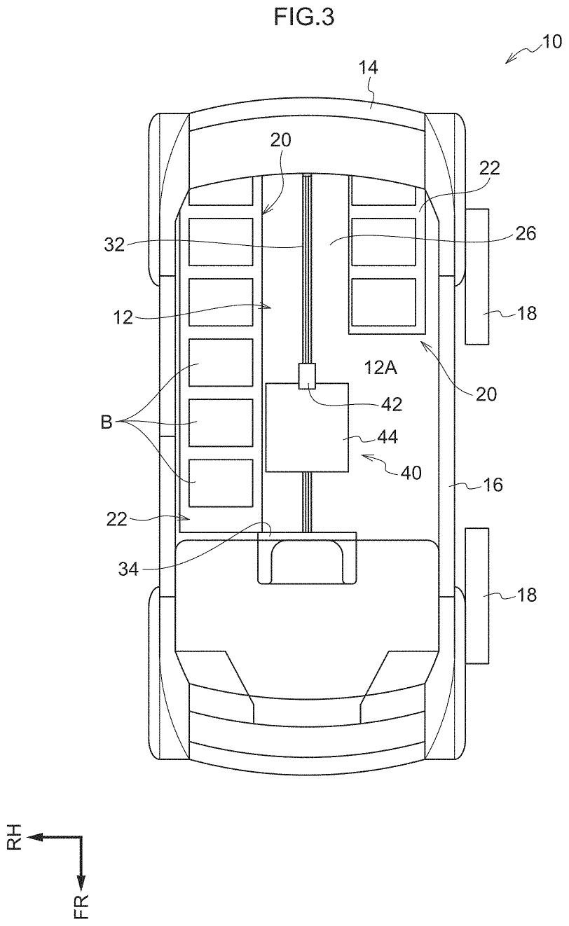

FIG. 1 is a perspective view illustrating the vehicle 10 according to the first exemplary embodiment as viewed from a front left side, with a left side of the vehicle 10 partially cut away. FIG. 2 is a perspective view illustrating the vehicle 10 as viewed from an upper left side, with an upper side of the vehicle 10 partially cut away. FIG. 3 is a plan view of the vehicle 10 with the upper side of the vehicle 10 partially cut away. Note that the vehicle 10 is a delivery vehicle for transporting packages B.

As illustrated in FIG. 1 to FIG. 3, the vehicle 10 includes a substantially box shaped vehicle body 14 formed with an interior cabin 12. As illustrated in FIG. 2 and FIG. 3, a side door opening 16 is formed in a vehicle width direction left side section of the vehicle body 14. The side door opening 16 places the interior and the exterior of the cabin 12 in communication with each other, and is configured to be opened and closed by a front and rear pair of sliding doors 18 that are configured to slide along a vehicle front-rear direction. The sliding doors 18 are configured to be opened and closed manually, and also configured to be opened and automatically by a non-illustrated movement mechanism. The movement mechanism is connected to a control device 50, described later, and is controlled by the control device 50. When the sliding doors 18 are in an open state, the packages B can be passed between the interior and exterior of the cabin 12 through the side door opening 16. Note that in the first exemplary embodiment, the side door opening 16 corresponds to an opening, and the sliding doors 18 correspond to a shutter section.

A housing area 20 in which the packages B are housed is provided inside the cabin 12. As illustrated in FIG. 1 to FIG. 3, the housing area 20 is configured by plural shelves 22 extending along the vehicle front-rear direction and arrayed in a vehicle vertical direction on both vehicle width direction sides of the housing area 20. The shelves 22 on the vehicle width direction right side are each formed with a length extending from a rear end of the vehicle body 14 to the rear of a driving seat inside the cabin 12. The shelves 22 on the vehicle width direction left side are each formed with a length extending from the rear end of the vehicle body 14 to a rear end of the side door opening 16 inside the cabin 12. Note that some of the shelves 22 are omitted from illustration in FIG. 1 and FIG. 2.

As illustrated in FIG. 1 and FIG. 2, a ceiling opening 26 is formed in a vehicle front-rear direction rear portion of a roof section (also referred to a vehicle roof section) 24 configuring an upper face of the vehicle body 14. The ceiling opening 26 places the interior and exterior of the cabin 12 in communication with each other. Note that although illustration of a roof body configuring the roof section 24 is omitted in FIG. 1 and FIG. 2, in practice, the ceiling opening 26 is formed penetrating a rear portion of the roof body configuring the roof section 24. Namely, a front portion of the roof section 24 is covered by the roof body. The ceiling opening 26 enables packages B to be passed in and out (transported) between the interior of the cabin 12 and a space above the roof section 24.

As illustrated in FIG. 1, a ceiling shutter 28 is provided at the ceiling opening 26. The ceiling opening 26 is configured to be opened and closed by the ceiling shutter 28. More specifically, the ceiling shutter 28 is configured to be disposed in a blocking position that blocks off the ceiling opening 26, and in a raised position 28Y, this being a position that opens up the ceiling opening 26 and is directly above the blocking position. Namely, in a state in which the ceiling opening 26 has been opened up, the ceiling shutter 28 is positioned directly above the ceiling opening 26 so as to be disposed covering the ceiling opening 26 in plan view of the vehicle.

A vehicle front-rear direction rear end portion of the ceiling shutter 28 is fixed to an upper end portion of an extender mechanism 30. The ceiling shutter 28 is supported by the extender mechanism 30 so as to be maintained in a horizontal orientation. A lower portion of the extender mechanism 30 is installed to the roof section 24. The extender mechanism 30 is configured including a concertina portion configured to extend and contracting in the vehicle vertical direction. The extender mechanism 30 is configured to extend or contract in response to actuation of an actuator (not illustrated in the drawings) so as to raise or lower the ceiling shutter 28. The actuator is included among drive devices 70, described later. This drive device 70 is connected to the control device 50, described later, and is controlled by the control device 50.

As illustrated in FIG. 1 to FIG. 3, a rail 32 that extends along the vehicle front-rear direction is provided at a floor 12A inside the cabin 12 of the vehicle 10. Both vehicle front-rear direction end portions of the rail 32 are screwed down using attachment fittings (not illustrated in the drawings) so as to fasten the rail 32 to the floor 12A. The rail 32 extends from the rear end of the vehicle body 14 to the rear of the driving seat. A movement range of a transfer unit 40, described later, is restricted by the attachment fittings of the rail 32.

Note that a partition 34 that partitions the driving seat from a space for a transfer operation performed by the transfer unit 40 is installed between the driving seat and a front end of the rail 32. This partition 34 prevents the transfer unit 40 from encroaching on the driving seat, thereby enabling occupant safety to be secured.

The transfer unit 40 (simplified in the drawings) is installed inside the cabin 12 of the vehicle 10. The transfer unit 40 is configured to move along the rail 32, and transfers packages B between the housing area 20 and the side door opening 16. Specifically, as illustrated in FIG. 1 to FIG. 3, the transfer unit 40 includes a support column 42 extending along the vehicle vertical direction, and a loading platform 44 that is configured to be raised and lowered along the support column 42 in the vertical direction.

Mobility wheels (not illustrated in the drawings) that allow the support column 42 to move along the rail 32 are provided at a lower end face of the support column 42. The mobility wheels are configured by a pair of wheels. The pair of wheels are provided on either side of the rail 32. One of the wheels is driven by a non-illustrated first motor, and the other of the wheels is supported by the support column 42 so as to be configured to rotate freely. The support column 42 is configured to move substantially horizontally along the rail 32 between a rear end of the cabin 12 and the rear of the driving seat accompanying rotation of the mobility wheels. Note that the first motor is included among the drive devices 70, described later. This drive device 70 is connected to the control device 50, described later, and is controlled by the control device 50.

The loading platform 44 is formed in a rectangular shape extending along a horizontal direction. The loading platform 44 is configured to be raised and lowered along the support column 42 on being driven by a non-illustrated second motor. The loading platform 44 is configured to be disposed at a position allowing a package B of a predetermined size housed on one of the shelves 22 inside the cabin 12 to be placed thereon. Note that the second motor is included among the drive devices 70, described later. This drive device 70 is connected to the control device 50, described later, and is controlled by the control device 50.

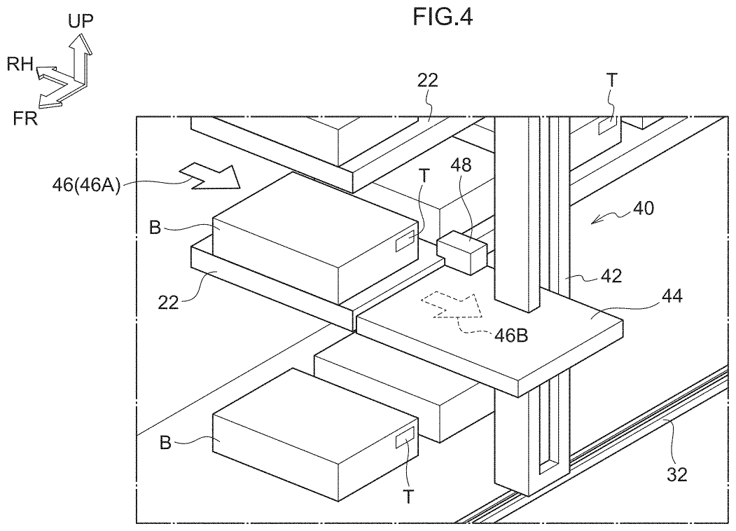

The transfer unit 40 also includes a loading mechanism 46 for placing packages B housed on the shelves 22 onto the loading platform 44. FIG. 4 is an enlarged perspective view illustrating part of the interior of the cabin 12 of the vehicle 10. As an example, as illustrated in FIG. 4, the loading mechanism 46 of the first exemplary embodiment is configured by a pusher mechanism 46A that pushes a package B housed on one of the shelves 22 onto the loading platform 44. The pusher mechanism 46A may be a mechanism that pushes just the package B onto the loading platform 44, or a mechanism that also pushes the corresponding shelf 22 onto the loading platform 44. In the latter case, after the shelf 22 has been pushed onto the loading platform 44 together with the package B, the shelf 22 may be returned to its original position while a bar (not illustrated in the drawings) suppresses rearward movement (movement in a backward direction) of the package B.

Alternatively, the loading mechanism 46 may be configured by a pulling mechanism 46B that pulls a package B housed on one of the shelves 22 onto the loading platform 44. The pulling mechanism 46B may be configured by a mechanism including a lifting mechanism that lifts the package B in an upward direction. After the package B has been lifted up by this lifting mechanism, the loading platform 44 is inserted between the package B and the shelf 22 and the package B loaded onto the loading platform 44, before the loading platform 44 is returned to its original position. Alternatively, the loading mechanism 46 may be configured by a robot arm (not illustrated in the drawings) that grips a package B housed on one of the shelves 22 and places the package B on the loading platform 44. Note that the respective configurations of the pusher mechanism 46A, the pulling mechanism 46B, and the robot arm may apply known technology, and so detailed explanation thereof is omitted.

A reader device 48 that reads package information relating to the packages B housed on the shelves 22 is provided on the loading platform 44 of the transfer unit 40. A two-dimensional code T, serving as verification information, is displayed on every side face of each of the packages B housed on the shelves 22. The two-dimensional code T is unique encoded package information corresponding to each of the packages B, and includes a delivery destination of the corresponding package B. A barcode or QR code (registered trademark) may be employed as the two-dimensional code. The reader device 48 acquires the package information by reading this two-dimensional code T. Note that the package information acquired by the reader device 48 is recorded in association with position information indicating the shelf 22 where this package B is housed. As an example, the position information indicating the shelf 22 may be manually input using a non-illustrated input device. Alternatively, a two-dimensional code representing position information corresponding to a shelf 22 may be displayed on the shelf 22, and the position information may be read by the reader device 48 together with the package information when housing a package B on the shelf 22.

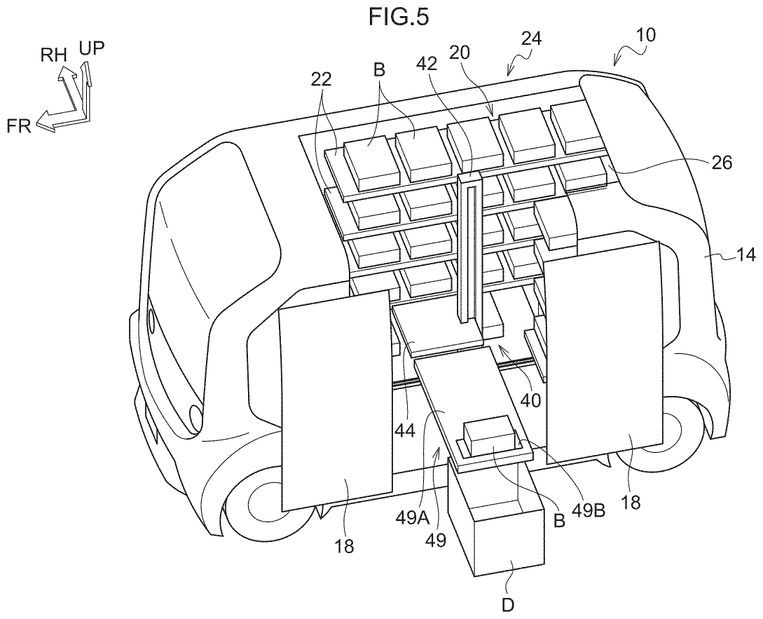

The transfer unit 40 also includes an unloading mechanism 49 for unloading a package B through the side door opening 16 after the package B has been placed on the loading platform 44. FIG. 5 is a perspective view illustrating an example of the unloading mechanism 49, with the upper side of the vehicle 10 partially cut away. As illustrated in FIG. 5, the unloading mechanism 49 includes a transportation platform 49A that extends from a vehicle width direction left end portion of the loading platform 44 toward the side door opening 16. The transportation platform 49A is installed so as to slope downward on progression toward the side door opening 16. A hole 49B through which a package B can drop is provided at a side door opening 16-side end portion of the transportation platform 49A. The transportation platform 49A may for example be folded and stowed below the loading platform 44, and then deployed for use when the sliding doors 18 have been placed in the open state after the vehicle 10 has arrived at the delivery destination.

Vehicle Control System

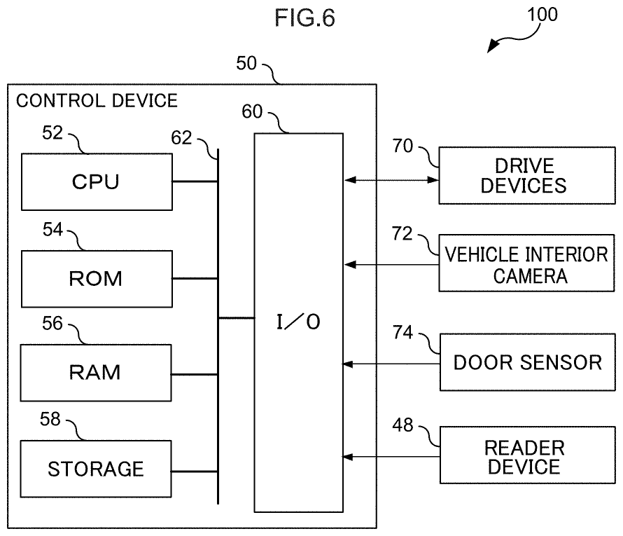

Next, explanation follows regarding a vehicle control system, serving as a delivery vehicle control system installed in the vehicle 10 described above. FIG. 6 is a block diagram illustrating a hardware configuration of a vehicle control system 100 installed in the vehicle 10. The vehicle control system 100 includes the control device 50. As illustrated in FIG. 6, the control device 50 includes a central processing unit (CPU) 52 serving as an example of a hardware processor, read only memory (ROM) 54, random access memory (RAM) 56, storage 58, and an input/output interface (I/O) 60. The CPU 52, the ROM 54, the RAM 56, the storage 58, and the I/O 60 are connected to each other through a bus 62.

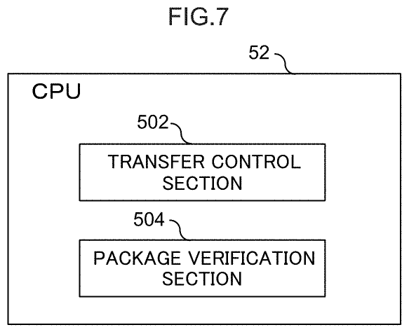

The CPU 52 is a central processing unit that executes various programs and controls respective sections. Namely, the CPU 52 reads a program from the ROM 54 serving as memory, and executes the program using the RAM 56 as a workspace. In the first exemplary embodiment, an execution program is stored in the ROM 54. By executing the execution program, the CPU 52 functions as a transfer control section 502 and a package verification section 504, illustrated in FIG. 7.

The ROM 54 stores the execution program that causes the CPU 52 to execute various processing. The RAM 56 serves as a workspace to temporarily store programs or data.

As an example, the storage 58 serving as a recording section is configured by a hard disk drive (HDD) or a solid state drive (SSD). The storage 58 records the package information acquired by the reader device 48 in association with the position information regarding the shelves 22 where the respective packages B are housed. The storage 58 is also configured to record images captured by a vehicle interior camera 72.

The I/O 60 is an interface for communicating with respective devices installed in the vehicle 10. The drive devices 70 including the movement mechanism, actuator, first motor, and second motor described previously, the vehicle interior camera 72, a door sensor 74, and the reader device 48 are connected to the I/O 60 of the first exemplary embodiment. Note that the I/O 60 and these respective devices may be connected together through various electronic control units (ECUs).

The vehicle interior camera 72 is installed to a side wall on one side of the cabin 12, and functions as an in-vehicle sensor that images the cabin 12 interior in order to detect a state inside the cabin 12.

The door sensor 74 functions as an open/closed state detection section that detects an open state and a closed state of the sliding doors 18. Known technology may be applied for the door sensor 74.

FIG. 7 is a block diagram illustrating an example of functional configuration of the CPU 52 of the first exemplary embodiment. The CPU 52 functions as the transfer control section 502 and the package verification section 504. The respective functional configuration is implemented by the CPU 52 reading and executing the execution program stored in the ROM 54.

The transfer control section 502 causes the transfer unit 40 to transfer a package B between the housing area 20 and the side door opening 16. Specifically, the transfer control section 502 controls driving of the first motor and the second motor included among the drive devices 70. Note that the transfer operation by the transfer control section 502 will be described in detail later.

When information regarding an upcoming delivery destination has been input, the package verification section 504 checks the input delivery destination information against the package information and position information recorded in the storage 58 in order to identify the package B to be delivered to the input delivery destination and the position of the shelf 22 where this package B is housed.

Processing Flow

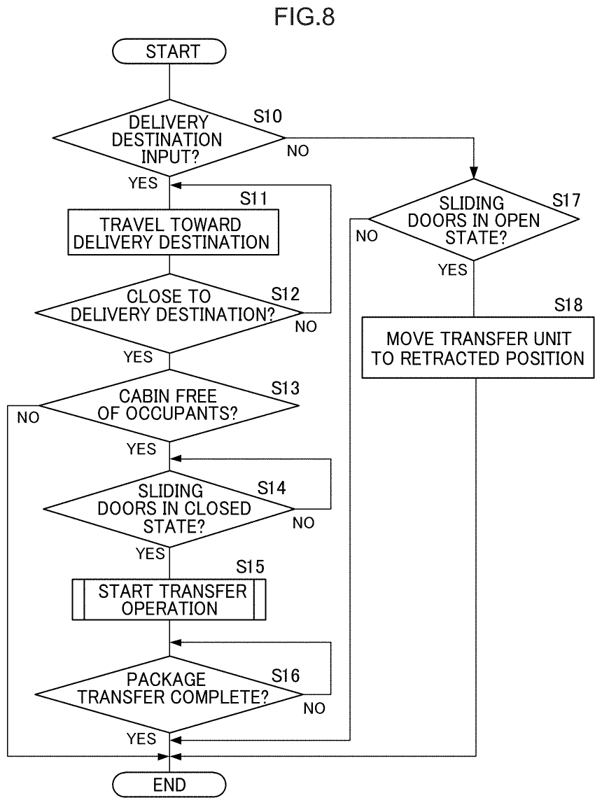

Next, explanation follows regarding a flow of a transfer operation sequence when transferring a package B from the vehicle 10 in the first exemplary embodiment. FIG. 8 is a flowchart illustrating an example of a flow of processing in the transfer operation performed by the vehicle control system 100.

First, the CPU 52 determines whether or not a delivery destination has been input (step 10). In cases in which a delivery destination has been input (step S10: YES), the CPU 52 causes the vehicle 10 to travel toward this delivery destination (step S11). Next, when the CPU 52 determines that the vehicle 10 has come close to the delivery destination (step S12: YES), the transfer control section 502 determines whether or not the cabin 12 is free of occupants based on an image of the interior of the cabin 12 captured by the vehicle interior camera 72 (step S13). Note that occupant refers here to an occupant other than a driver seated in the driving seat. Specifically, determination is made as to whether or not an occupant is present at the vehicle rear of the partition 34. On the other hand, in cases in which the CPU 52 determines that the vehicle 10 is not yet close to the delivery destination (step S12: NO), the CPU 52 returns to the processing of step S11, and continues to cause the vehicle 10 to travel toward the delivery destination (step S11).

In cases in which the CPU 52 determines that no occupants are present at step S13 (step S13: YES), the transfer control section 502 determines whether or not the sliding doors 18 are in the closed state based on input from the door sensor 74 (step S14). On the other hand, in cases in which an occupant is determined to be present (step S13: NO), the transfer control section 502 ends the processing without causing the transfer unit 40 to perform the package B transfer operation.

In cases in which the CPU 52 determines that the sliding doors 18 are in the open state at step S14 (step S14: NO), the CPU 52 repeats the processing of step S14 until the sliding doors 18 are in the closed state. In cases in which the CPU 52 determines that the sliding doors 18 are in the closed state (step S14: YES), the transfer control section 502 causes the transfer unit 40 to start the transfer operation (step S15).

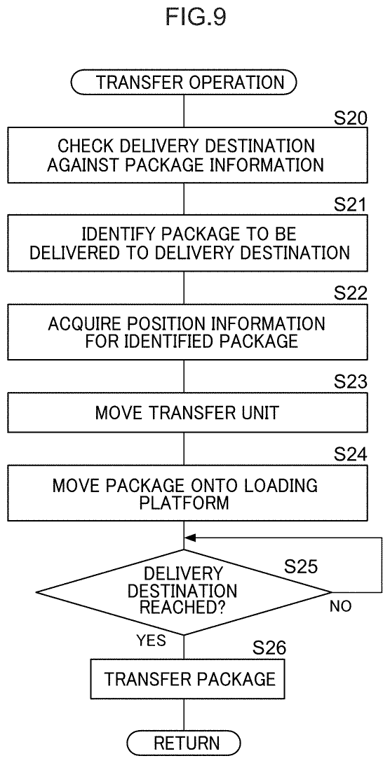

Explanation follows regarding an example of the transfer operation by the transfer unit 40. FIG. 9 is a flowchart illustrating an example of a transfer operation for a package B. First, the package verification section 504 checks the input delivery destination against the package information recorded in the storage 58 (step S20) so as to identify the package B to be delivered to the delivery destination (step S21). Next, the package verification section 504 acquires the position information for the shelf 22 where the package B is housed based on the position information associated with the identified package B (step S22).

Next, by driving the drive devices 70, the transfer control section 502 causes the transfer unit 40 to move to the position of the shelf 22 based on the acquired position information (step S23). Specifically, the transfer control section 502 drives the first motor to move the support column 42 in the vehicle front-rear direction, and drives the second motor to move the loading platform 44 in the vehicle vertical direction, such that the loading platform 44 is moved to the position of the target shelf 22.

Next, the transfer control section 502 drives the pusher mechanism 46A to move the package B housed on the shelf 22 onto the loading platform 44 (step S24). The CPU 52 then determines whether or not the delivery destination has been reached (step S25). In cases in which the CPU 52 determines that the delivery destination has been reached (step S25: YES), the transfer control section 502 causes the transfer unit 40 to transfer the package B that has been loaded onto the loading platform 44 such that the package B is transferred to the exterior of the cabin 12 through the side door opening 16 (step S26).

Specifically, first the transfer control section 502 controls the movement mechanism included among the drive devices 70 so as to place the sliding doors 18 in the open state. Next, the transfer control section 502 deploys the transportation platform 49A from its folded state by driving a non-illustrated drive section, and a worker places a transportation box D directly under the hole 49B (see FIG. 5). As an example, the transfer control section 502 causes the pusher mechanism 46A (see FIG. 4) to push the package B that has been loaded onto the loading platform 44, such that the package B moves downward over the transportation platform 49A and is unloaded into the transportation box D through the hole 49B.

On the other hand, in cases in which the CPU 52 determines that the delivery destination has not yet been reached at step S25 (step S25: NO), the processing of step S25 is repeated until the delivery destination is reached.

Returning to FIG. 8, the CPU 52 determines whether or not transfer of the package B is complete (step S16). In cases in which the CPU 52 determines that the transfer is complete (step S16: YES), the CPU 52 ends all related processing. In cases in which the CPU 52 determines that the transfer of the package B is not complete (step S16: NO), the CPU 52 repeats the processing of step S16 until the transfer of the package B is complete.

On the other hand, in cases in which the CPU 52 determines that no delivery destination has been input at step S10 (step S10: NO), the transfer control section 502 determines whether or not the sliding doors 18 are in the open state based on input from the door sensor 74 (step S17). In cases in which the CPU 52 determines that the sliding doors 18 are in the closed state (step S17: NO), the CPU 52 ends all related processing. In cases in which the CPU 52 determines that the sliding doors 18 are in the open state (step S17: YES), the transfer control section 502 moves the transfer unit 40 to a retracted position separated from the side door opening 16 (step S18), and ends all related processing.

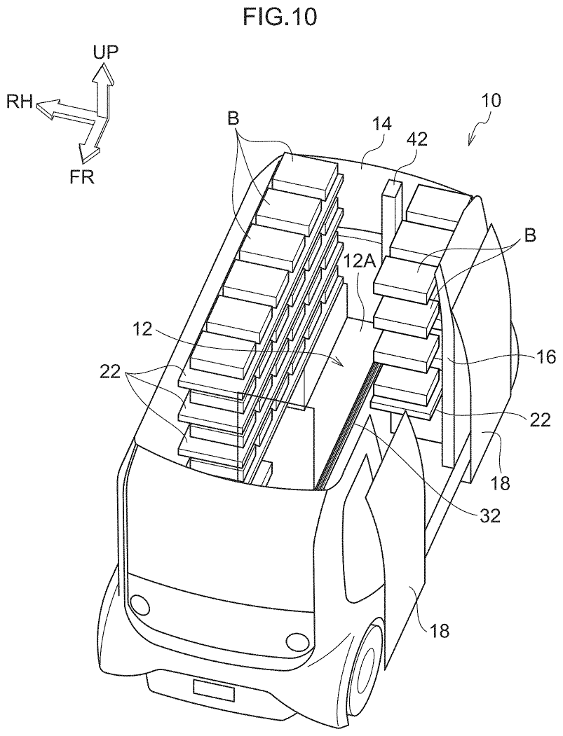

FIG. 10 is a perspective view of the vehicle 10 in which the upper side of the vehicle 10 is partially cut away, in order to explain an example of a retraction operation. The transfer control section 502 drives the first motor included among the drive devices 70, thereby causing the transfer unit 40 to move away from the side door opening 16 to the retracted position, namely the vehicle rear end portion of the rail 32, as illustrated in FIG. 10.

### Operation and Advantageous Effects

The vehicle 10 of the first exemplary embodiment includes the rail 32 provided inside the cabin 12, and the transfer unit 40 that is configured to move along the rail 32 so as to transfer a package B between the housing area 20 that houses the packages B and the side door opening 16 that places the interior and exterior of the cabin 12 in communication with each other. This enables the package B to be carried from the housing area 20 toward the side door opening 16 by the transfer unit 40 moving along the rail 32. The packages B are thereby able to be transported without employing bulky equipment such as a conveyor that requires motive force, thereby enabling a simpler configuration and more package loading space to be secured than in cases in which a conveyor is employed.

Moreover, the vehicle control system 100 of the first exemplary embodiment causes the transfer unit 40 to perform the package B transfer operation in cases in which the cabin 12 is detected to be free of occupants and the sliding doors 18 are detected to be in the closed state. Thus, the transfer unit 40 is only operated when no occupants are present inside the cabin 12, thereby enabling occupant safety to be secured. Since there is no risk of the transfer unit 40 coming into contact with an occupant or worker inside the cabin 12, emergency stoppages and the like can be avoided during the package B transfer operation, thereby enabling the operating efficiency of the transfer unit 40 to be improved.

Moreover, in the vehicle control system 100 of the first exemplary embodiment, when the sliding doors 18 are in the open state and no delivery destination has been input, the transfer unit 40 is moved away from the side door opening 16 to the retracted position, thereby enabling the transfer unit 40 to be suppressed from getting in the way of a worker. This enables working space to be secured in the vicinity of the side door opening 16, thereby enabling operating efficiency to be improved when a worker is loading up with packages.

Note that although the transportation platform 49A is disposed sloping downward on progression toward the side door opening 16 in the first exemplary embodiment, there is no limitation thereto. For example, in cases in which the transportation platform 49A is configured by a roller belt conveyor (not illustrated in the drawings) provided with plural rollers with rotation shafts extending along the vehicle front-rear direction, the transportation platform 49A may be disposed without sloping, namely horizontally. Note that even if the transportation platform 49A is configured by a roller belt conveyor, the transportation platform 49A may still be disposed sloping downward on progression toward the side door opening 16.

Although the ceiling shutter 28 is raised and lowered to open and close the ceiling opening 26 in the first exemplary embodiment, there is no limitation thereto. For example, the ceiling shutter 28 may have a sliding structure configured to slide horizontally along the vehicle front-rear direction, or a sliding structure configured to slide horizontally along the vehicle width direction.

Although the ceiling opening 26 and the ceiling shutter 28 are provided at the vehicle 10 in the first exemplary embodiment, there is no limitation thereto. A configuration may be applied in which the ceiling opening 26 and the ceiling shutter 28 are not provided.

Although the door sensor 74 functions as an open/closed state detection section to detect an open/closed state of the sliding doors 18 in the first exemplary embodiment, there is no limitation thereto. A door sensor 74A functioning as an open/closed state detection section to detect an open/closed state of the ceiling shutter 28 may be additionally provided.

### Modified Example of First Exemplary Embodiment

In cases in which the door sensor 74A is provided as an open/closed state detection section to detect an open/closed state of the ceiling shutter 28, the ceiling opening 26 corresponds to an opening, and the ceiling shutter 28 corresponds to a shutter section. In such cases, at step S14 in the flowchart in FIG. 8, the CPU 52 determines an open/closed state of the ceiling shutter 28 rather than of the sliding doors 18. Moreover, at step S26 of the flowchart in FIG. 9, the transfer control section 502 causes the transfer unit 40 to perform transfer processing of a package B so as to transfer the package B that has been loaded onto the loading platform 44 to the exterior of the cabin 12 through the ceiling opening 26.

The transfer unit 40 of this modified example may for example include a drone (not illustrated in the drawings) serving as the unloading mechanism 49 for unloading the package B that has been loaded onto the loading platform 44 through the ceiling opening 26. This modified example may be configured without the transportation platform 49A.

At step S26, the transfer control section 502 first controls an actuator included among the drive devices 70 so as to place the ceiling shutter 28 in the open state. The transfer control section 502 then causes the support column 42 to move in the vehicle front-rear direction such that the loading platform 44 loaded with the package B is positioned directly below the ceiling opening 26, before moving the loading platform 44 in the vehicle vertical direction. The transfer control section 502 then causes the package B on the loading platform 44 to be unloaded through the ceiling opening 26 using the drone.

This modified example enables similar advantageous effects to those of the first exemplary embodiment to be obtained. Note that an unloading mechanism 49 for unloading the package B that has been loaded onto the loading platform 44 through the ceiling opening 26, and an unloading mechanism 49 for unloading the package B that has been loaded onto the loading platform 44 through the side door opening 16 may both be provided.

### Second Exemplary Embodiment

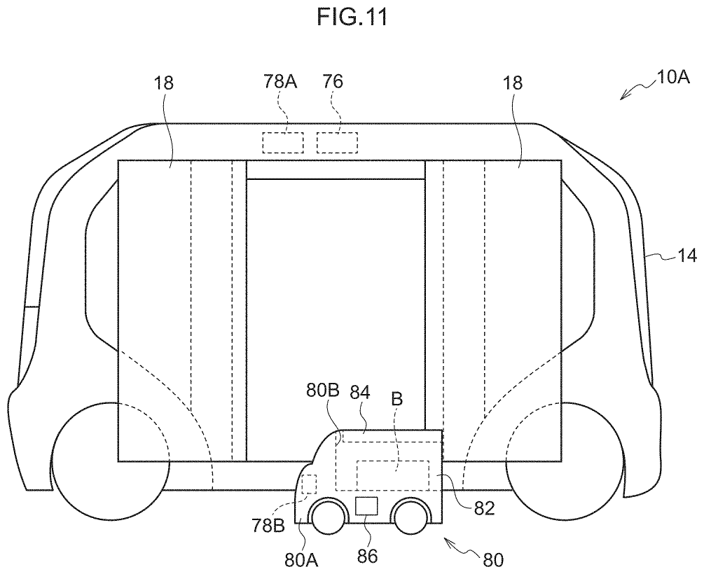

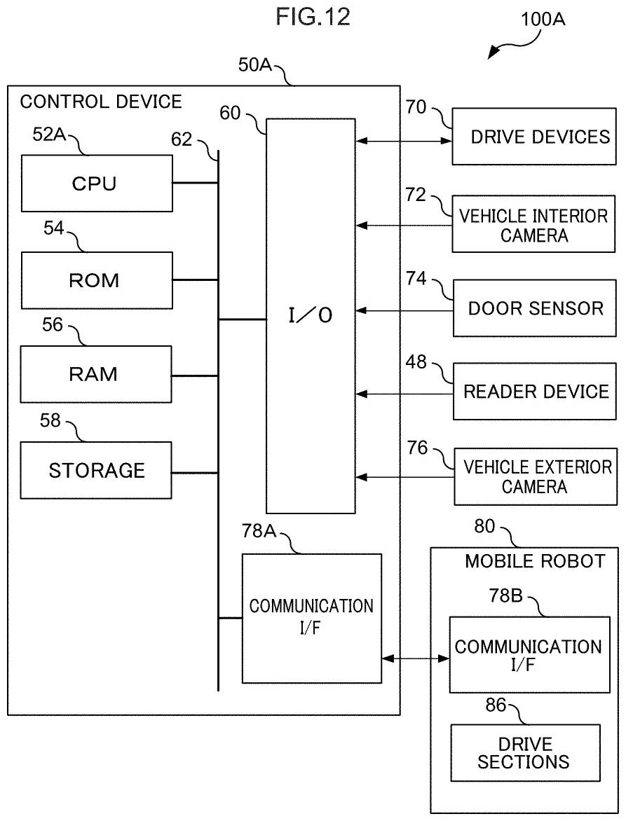

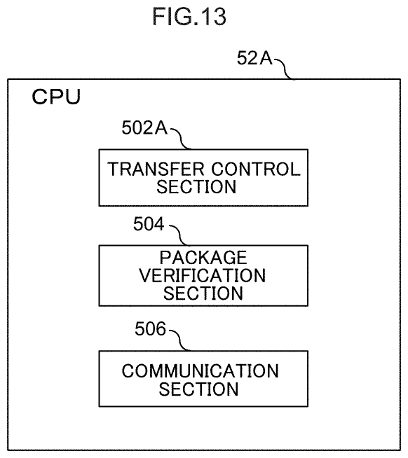

Next, explanation follows regarding a vehicle control system 100A serving as a delivery vehicle control system installed in a vehicle 10A according to a second exemplary embodiment of the present disclosure, with reference to FIG. 11 to FIG. 13. Note that similar configuration to that in the first exemplary embodiment is allocated the same reference numerals and explanation thereof is omitted. Detailed explanation follows regarding only those points that differ from the first exemplary embodiment. FIG. 11 is a side view illustrating the vehicle control system 100A according to the second exemplary embodiment. FIG. 12 is a block diagram illustrating a hardware configuration of the vehicle control system 100A. FIG. 13 is a block diagram illustrating an example of functional configuration of a CPU 52A of a control device 50A of the vehicle control system 100A.

Vehicle

As illustrated in FIG. 11, in addition to the configuration of the first exemplary embodiment, the vehicle 10A installed with the vehicle control system 100A according to the second exemplary embodiment further includes a vehicle exterior camera 76, and a communication interface (I/F) 78A for communicating with a mobile robot 80, described later. As illustrated in FIG. 11, the vehicle exterior camera 76 and the communication I/F 78A are provided on the ceiling inside the cabin 12 in the vicinity of the sliding doors 18. The vehicle exterior camera 76 is installed so as to be configured to image the surroundings of a mobile robot 80 positioned in the vicinity of the sliding doors 18 of the vehicle 10A, and functions as an object detection section that detects whether or not an object is present within a predetermined peripheral range around the mobile robot 80.

Explanation follows regarding the mobile robot 80. The mobile robot 80 is an example of a moving body. As illustrated in FIG. 11, the mobile robot 80 is configured including a substantially box shaped robot body 80A, a housing compartment 82 configured to house a package B inside the robot body 80A, and a lid 84 that shuts off a hole 80B in an upper portion of the housing compartment 82. The lid 84 is supported so as to be configured to move in the vehicle front-rear direction by rails (not illustrated in the drawings) provided on either vehicle width direction side of the hole 80B. The hole 80B is opened up when the lid 84 is moved toward the vehicle rear.

As illustrated in FIG. 11 and FIG. 12, the mobile robot 80 is provided with a communication I/F 78B for communicating with the vehicle 10A, and drive sections 86 that drive the robot body 80A and the lid 84. In cases in which the mobile robot 80 is available to receive a package B, the communication I/F 78B outputs a signal indicating cooperation readiness to the vehicle 10A. Known technology may be employed for the drive sections 86, and so detailed explanation thereof is omitted. Note that although not illustrated in the drawings, the mobile robot 80 includes a CPU serving as a control section. The CPU reads programs from ROM or storage, and executes various programs using RAM as a workspace. The communication I/F 78B outputs the above-mentioned signal under a command from the CPU.

The communication I/F 78A provided at the vehicle 10A receives the signal indicating cooperation readiness output from the communication I/F 78B provided at the mobile robot 80. Note that known wireless communication technology may be applied as a method of communication between the communication I/F 78A of the vehicle 10A and the communication I/F 78B of the mobile robot 80.

Vehicle Control System

As illustrated in FIG. 12, the vehicle control system 100A installed in the vehicle 10A includes the control device 50A. The control device 50A includes the CPU 52A serving as a processor, the ROM 54 serving as memory, the RAM 56, the storage 58, the I/O 60, and the communication I/F 78A, these being connected together through the bus 62.

The CPU 52A executes an execution program stored in the ROM 54 so as to function as a transfer control section 502A, the package verification section 504, and a communication section 506, illustrated in FIG. 13. In addition to the drive devices 70, the vehicle interior camera 72, the door sensor 74, and the reader device 48, the vehicle exterior camera 76 is also connected to the I/O 60 of the second exemplary embodiment. The storage 58 of the second exemplary embodiment is configured to record images captured by the vehicle exterior camera 76.

As illustrated in FIG. 13, the CPU 52A of the second exemplary embodiment functions as the transfer control section 502A, the package verification section 504, and the communication section 506. The respective functional configuration is implemented by the CPU 52A reading the execution program stored in the ROM 54 and executing this program.

When the communication I/F 78A receives the signal indicating cooperation readiness output from the communication I/F 78B provided at the mobile robot 80, the communication section 506 confirms cooperation readiness between the vehicle 10A and the mobile robot 80. Note that the mobile robot 80 may for example output the signal indicating cooperation readiness from the communication I/F 78B in cases in which the lid 84 is in an open state and the mobile robot 80 is available to receive a package B. The transfer control section 502A is described in detail later.

Processing Flow

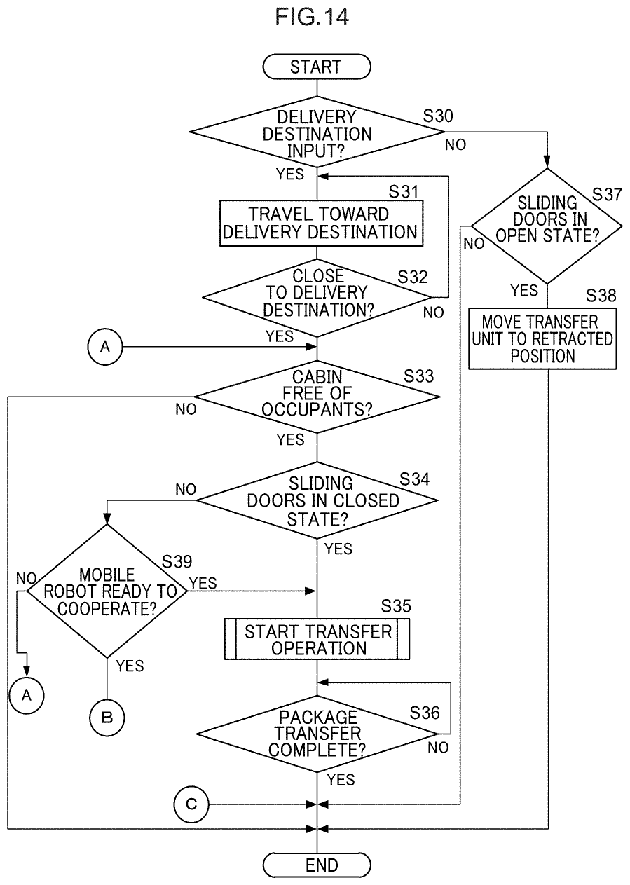

Next, explanation follows regarding a flow of a transfer operation sequence in which a package B is transferred by the vehicle 10A in the second exemplary embodiment. FIG. 14 is a flowchart illustrating an example of a flow of transfer operation processing performed by the vehicle control system 100A. Note that the processing of step S30 to step S38 in FIG. 14 is the same as the processing of step S10 to step S18 in the flowchart of FIG. 8, and so detailed explanation thereof is omitted herein.

As illustrated in FIG. 14, in the second exemplary embodiment, in cases in which the CPU 52A determines that the sliding doors 18 are not in the closed state at step S34 (step S34: NO), namely in cases in which the sliding doors 18 are in the open state, the communication section 506 determines whether or not the mobile robot 80 has indicated it is ready to cooperate with the vehicle 10A (step S39). In cases in which the mobile robot 80 is ready to cooperate (step S39: YES), the transfer control section 502A causes the transfer unit 40 to start the transfer operation (step S35).

Note that the transfer operation of the second exemplary embodiment involves the same processing as that illustrated in the flowchart in FIG. 9 for the first exemplary embodiment. However, the mobile robot 80 with the lid 84 in the open state is employed instead of the transportation box D in FIG. 5.

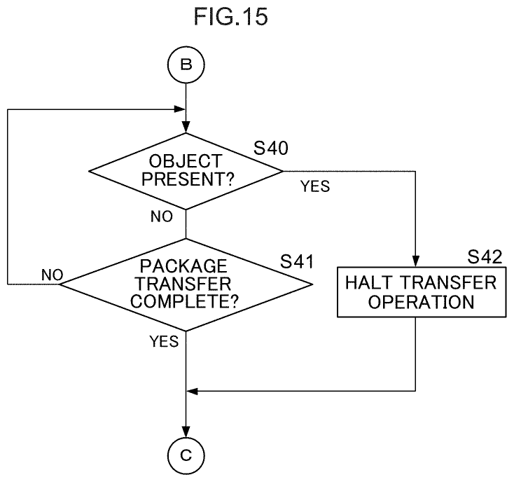

In parallel to the transfer control section 502A starting the transfer operation, processing transitions to B illustrated in FIG. 15. At step S40, the transfer control section 502A determines whether or not an object is present within the predetermined peripheral range of the mobile robot 80 based on an image of the cabin 12 exterior captured by the vehicle exterior camera 76. In cases in which determination is made that an object is present at step S40 (step S40: YES), the transfer control section 502A controls such that transfer of the package B by the transfer unit 40 is not performed (step S42), the processing of the CPU 52A transitions to C, and the all related processing is ended as illustrated in FIG. 14.

On the other hand, in cases in which no objects are determined to be present at step S40 (step S40: NO), the CPU 52A determines whether or not transfer of the package B is complete (step S41). In cases in which determination is made that the transfer is complete (step S41: YES), the processing of the CPU 52A transitions to C, and all related processing is ended as illustrated in FIG. 14. In cases in which the CPU 52A determines that transfer of the package B is not complete (step S41: NO), the CPU 52A returns to the processing of step S40 to perform ongoing determination as to whether or not an object is present.

Returning to FIG. 14, in cases in which the communication section 506 determines that the mobile robot 80 is not ready to cooperate with the vehicle 10A at step S39 (step S39: NO), the processing of the CPU 52A transitions to A, and the processing of step S33 onward is repeated.

### Operation and Advantageous Effects

In the vehicle control system 100A of the second exemplary embodiment, when cooperation readiness between the vehicle 10A and the mobile robot 80 has been confirmed, the transfer unit 40 is made to perform the package B transfer operation, even in cases in which the sliding doors 18 are detected to be in an open state. This enables the package B transfer operation to be performed by the transfer unit 40 even if the sliding doors 18 are in the open state, as long as there is cooperation readiness between the vehicle 10A and the mobile robot 80. This enables the package B transfer operation to be performed if required even if the sliding doors 18 are in an open state, such that operating efficiency is improved.

Moreover, when the presence of an object is detected within the predetermined peripheral range of the mobile robot 80, the vehicle control system 100A of the second exemplary embodiment controls such that transfer of the package B is not performed by the transfer unit 40, thereby enabling the safety of occupants, workers, and the like to be secured.

Note that although the lid 84 of the mobile robot 80 is opened and closed in the horizontal direction in the second exemplary embodiment, there is no limitation thereto. For example, a lid that swings toward the inside of the housing compartment 82, or a shutter that moves along a side wall of the housing compartment 82 may be employed instead.

Although the mobile robot 80 is applied as a moving body in the second exemplary embodiment, there is no limitation thereto. For example, a radio-controlled car, a drone, or the like that includes a housing compartment may be employed as a moving body.

Although in the second exemplary embodiment, processing to determine whether or not an object is present within the predetermined peripheral range of the mobile robot 80 is performed in parallel to the transfer operation by the transfer unit 40 in cases in which the mobile robot 80 is ready to cooperate at step S39, there is no limitation thereto. For example, the processing of B in FIG. 14 onward, namely the processing in the flowchart in FIG. 15, may be omitted. In cases in which the processing of B onward is omitted, the vehicle exterior camera 76 may be omitted from the vehicle 10A.

Although the communication I/F 78A is provided at the control device 50A and the communication I/F 78B is provided at the mobile robot 80 in the vehicle control system 100A of the second exemplary embodiment, there is no limitation thereto. For example, a configuration may be applied in which an image indicating cooperation readiness is displayed somewhere on the robot body 80A when the mobile robot 80 is ready to cooperate, and the control device 50A includes a recognition device (such as a camera) for recognizing such an image. In such cases, when the recognition device reads the image indicating cooperation readiness on the robot body 80A, the communication section 506 confirms that there is cooperation readiness between the vehicle 10A and the mobile robot 80.

The previously-described modified example of the first exemplary embodiment may also be applied to the vehicle control system 100A of the second exemplary embodiment. In such cases, a package B unloaded by the drone is housed in the housing compartment 82 of the mobile robot 80.

### Third Exemplary Embodiment

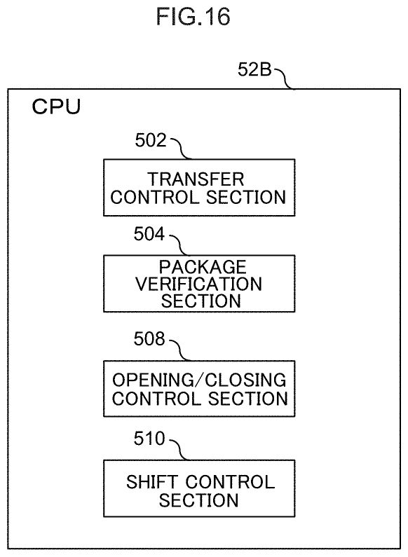

Next, explanation follows regarding a third exemplary embodiment of a vehicle control system 100B serving as a delivery vehicle control system installed in the vehicle 10, with reference to FIG. 16. Note that the vehicle control system 100B is suitable for installation in either the vehicle 10 of the first exemplary embodiment or the vehicle 10A of the second exemplary embodiment. Explanation follows regarding an example in which vehicle control system 100B is installed in the vehicle 10 of the modified example of the first exemplary embodiment. Namely, in the third exemplary embodiment, packages B are unloaded through the ceiling opening 26. FIG. 16 is a block diagram illustrating an example of functional configuration of a CPU 52B serving as a processor of a control device 50B of the vehicle control system 100B.

Vehicle Control System

As illustrated in FIG. 16, in addition to the transfer control section 502 and the package verification section 504, the CPU 52B also functions as an opening/closing control section 508 and a shift control section 510. When a parking position is selected as a shift range of a shift lever of the vehicle 10, the opening/closing control section 508 permits an opening/closing operation of the ceiling shutter 28 (see FIG. 1). Specifically, the opening/closing control section 508 operates the corresponding actuator (not illustrated in the drawings) such that the extender mechanism 30 is able to operate to raise or lower the ceiling shutter 28.

In other words, the opening/closing operation of the ceiling shutter 28 is prevented when a position other than the parking position has been selected as the shift range of the shift lever. Specifically, the opening/closing control section 508 halts operation of the corresponding actuator, such that operation of the extender mechanism 30 to raise or lower the ceiling shutter 28 is halted.

The shift control section 510 prevent s selection of any shift position other than the parking position as the shift range of the shift lever of the vehicle 10 while an opening/closing operation of the ceiling shutter 28 is in progress. Namely, a shift change cannot be performed while an opening/closing operation of the ceiling shutter 28 is in progress.

Processing Flow

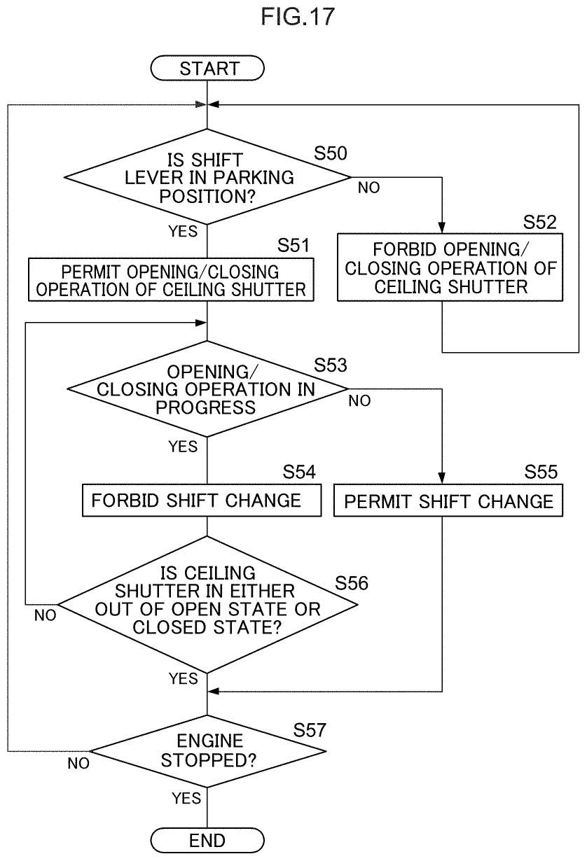

Next, explanation follows regarding a flow of a transfer operation sequence to transfer a package B from the vehicle 10 in the third exemplary embodiment. FIG. 17 is a flowchart illustrating an example of a flow of the transfer operation processing performed by the vehicle control system 100B.

First, the CPU 52B determines whether or not the parking position has been selected as the shift range of the shift lever of the vehicle 10 (step S50). In cases in which the parking position has been selected (step S50: YES), the opening/closing control section 508 permits an opening/closing operation of the ceiling shutter 28 (step S51). In cases in which the parking position has not been selected as the shift range of the shift lever of the vehicle 10 (step S50: NO), the opening/closing control section 508 prevent s an opening/closing operation of the ceiling shutter 28 (step S52), and the CPU 52B returns to the processing of step S50.

When an opening/closing operation of the ceiling shutter 28 has been permitted at step S51, the shift control section 510 determines whether or not an opening/closing operation of the ceiling shutter 28 is in progress (step S53). In cases in which an opening/closing operation of the ceiling shutter 28 is in progress (step S53: YES), the shift control section 510 prevent s selection of any shift position other than the parking position as the shift range of the shift lever of the vehicle 10 (step S54). Namely, any shift change is prevented. In cases in which an opening/closing operation of the ceiling shutter 28 is not in progress (step S53: NO), the shift control section 510 permits selection of a shift position other than the parking position as the shift range of the shift lever of the vehicle 10 (step S55). Namely, a shift change is permitted.

After a shift change has been prevented at step S54, the CPU 52B determines whether or not the ceiling shutter 28 is in either out of the open state or the closed state (step S56). Note that the ceiling shutter 28 being in the open state refers to the ceiling opening 26 being in an opened-up state, and the ceiling shutter 28 being in the closed state refers to the ceiling opening 26 being in a blocked-off state. In cases in which the ceiling shutter 28 is in neither the open state nor the closed state (step S56: NO), the CPU 52B returns to the processing of the step S53, and the processing of step S53 onward is repeated.

In cases in which the ceiling shutter 28 is in either out of the open state or the closed state (step S56: YES), and in cases in which after a shift change has been permitted at step S55, the CPU 52B determines whether or not the engine of the vehicle 10 has stopped (step S57). In cases in which the engine has not stopped (step S57: NO), the CPU 52B returns to the processing of step S50. In cases in which the engine has stopped (step S57: YES), the CPU 52B ends all related processing.

### Operation and Advantageous Effects

In the vehicle control system 100B of the third exemplary embodiment, an opening/closing operation of the ceiling shutter 28 is permitted when the parking position has been selected as the shift range of the shift lever of the vehicle 10, thereby enabling opening and closing of the ceiling shutter 28 to be prevented while the vehicle 10 is in motion.

Moreover, in the vehicle control system 100B of the third exemplary embodiment, selection of a shift position other than the parking position as the shift range of the shift lever is prevented while an opening/closing operation of the ceiling shutter 28 is in progress, thereby enabling the vehicle 10 to be prevented from moving while an opening/closing operation of the ceiling shutter 28 is in progress.

Note that although the partitioning panel 34 is installed as an example in order to partition the driving seat from the space in which the transfer operation is performed by the transfer unit 40 in the first to third exemplary embodiments, there is no limitation thereto. Any configuration may be applied as long as the configuration enables the driving seat to be partitioned from the space in which the transfer operation is performed by the transfer unit 40. For example, a photoelectric sensor employing photoelectric tubes may be employed. In such cases, configuration may be such that a light projecting portion and a light receiving portion of the photoelectric sensor are installed spaced apart from each other in the vehicle width direction at the rear of the driving seat, and the transfer operation by the transfer unit 40 is halted in cases in which an object has been detected by the photoelectric sensor.

Although the rail 32 is only provided running along the vehicle front-rear direction in the first to third exemplary embodiments, there is no limitation thereto. For example, a further rail 32 may be provided extending from the rail 32 toward the side door opening 16 on the vehicle width direction left side.

Although the two-dimensional code T is employed as verification information for the packages B in the first to third exemplary embodiments, there is no limitation thereto. For example, radio frequency identification (RFID) employing an IC tag or the like may be employed instead.

Although a format in which the side door opening 16 corresponds to an opening and the sliding doors 18 correspond to a shutter section and a format in which the ceiling opening 26 corresponds to an opening and the ceiling shutter 28 corresponds to a shutter section have been explained in the first to third exemplary embodiments, there is no limitation thereto. For example, a back door opening and a back door that opens and closes this back door opening may be provided at a rear end of the vehicle 10, 10A, such that the back door opening corresponds to an opening, and the back door corresponds to a shutter section. In such cases, both or either one out of the side door opening 16 or the ceiling opening 26 and the corresponding sliding doors 18 or ceiling shutter 28 may be omitted.

Although the sliding doors 18 are employed as doors that open and close the side door opening 16 in the first to third exemplary embodiments, there is no limitation thereto. A hinged door may be employed instead.

Although examples have been described above, the present disclosure is not limited to the above description, and obviously various other modifications may be implemented within a range not departing from the spirit of the present disclosure.

What is claimed is:

1. A delivery vehicle, comprising:
a vehicle body;
an opening that is provided at the vehicle body, that is configured to be opened and closed by a shutter section, and that is configured to place a cabin interior and a cabin exterior in communication with each other;
a housing area that is provided at the cabin interior and that is configured to house a package;
a rail that is provided at the cabin interior; and
a transfer unit that is configured to move along the rail and to transfer the package between the housing area and the opening.

2. A delivery vehicle control system for installation in the delivery vehicle of claim 1, the delivery vehicle control system comprising:
a memory; and
a processor coupled to the memory, the processor being configured to:
detect a state of the cabin interior and an open/closed state of the shutter section; and
cause the transfer unit to perform a transfer operation for the package in a case in which the cabin interior has been detected to be free of any occupant and the shutter section has been detected to be in a closed state.

3. A delivery vehicle control system for installation in the delivery vehicle of claim 1, the delivery vehicle control system comprising:
a memory; and
a processor coupled to the memory, the processor being configured to:
detect an open/closed state of the shutter section; and
cause the transfer unit to move to a retracted position separated from the opening in a case in which the shutter section has been detected to be in an open state.

4. The delivery vehicle control system of claim 2, wherein the processor is configured to cause the transfer unit to move to a retracted position separated from the opening in a case in which the shutter section has been detected to be in an open state.

5. The delivery vehicle control system of claim 2, wherein the processor is configured to:
confirm cooperation readiness between the delivery vehicle and a moving body configured to move at an exterior of the delivery vehicle and to transport the package; and
cause the transfer unit to perform a transfer operation for the package, even when the shutter section has been detected to be in an open state, in a case in which the cooperation readiness between the delivery vehicle and the moving body has been confirmed.

6. The delivery vehicle control system of claim 5, wherein the processor is configured to:
detect whether or not an object is present within a predetermined peripheral range of the moving body; and
effect control such that transfer of the package is not performed by the transfer unit in a case in which the presence of an object has been detected within the predetermined peripheral range of the moving body.

7. The delivery vehicle control system of claim 2, wherein:
the opening is a ceiling opening provided at a vehicle roof section;
the shutter section is a ceiling shutter provided at the ceiling opening; and
the processor is configured to permit an opening/closing operation of the ceiling shutter in a case in which a parking position has been selected as a shift range of a shift lever of the delivery vehicle.

8. The delivery vehicle control system of claim 7, wherein the processor is configured to prevent selection of a shift position other than the parking position as the shift range of the shift lever while an opening/closing operation of the ceiling shutter is in progress.

9. A delivery vehicle control method for a delivery vehicle control system including a memory and a processor coupled to the memory, the delivery vehicle control system being installed in a delivery vehicle including:
a vehicle body;
an opening that is provided at the vehicle body, that is configured to be opened and closed by a shutter section, and that is configured to place a cabin interior and a cabin exterior in communication with each other;
a housing area that is provided at the cabin interior and that is configured to house a package;
a rail that is provided at the cabin interior; and
a transfer unit that is configured to move along the rail and to transfer the package between the housing area and the opening,
the delivery vehicle control method comprising, by the processor:
detecting a state of the cabin interior and an open/closed state of the shutter section, and causing the transfer unit to perform a transfer operation for the package in a case in which the cabin interior has been detected to be free of any occupant and the shutter section has been detected to be in a closed state; or
detecting an open/closed state of the shutter section and causing the transfer unit to move to a retracted position separated from the opening in a case in which the shutter section has been detected to be in an open state.

10. The delivery vehicle control method of claim 9, further comprising causing the transfer unit to move to the retracted position separated from the opening in a case in which the shutter section has been detected to be in an open state.

11. The delivery vehicle control method of claim 9, further comprising:
confirming cooperation readiness between the delivery vehicle and a moving body configured to move at an exterior of the delivery vehicle and to transport the package; and
causing the transfer unit to perform a transfer operation for the package, even when the shutter section has been detected to be in an open state, in a case in which the cooperation readiness between the delivery vehicle and the moving body has been confirmed.

12. The delivery vehicle control method of claim 11, further comprising:
detecting whether or not an object is present within a predetermined peripheral range of the moving body; and
effecting control such that transfer of the package is not performed by the transfer unit in a case in which the presence of an object has been detected within the predetermined peripheral range of the moving body.

13. The delivery vehicle control method of claim 9, wherein:
the opening is a ceiling opening provided at a vehicle roof section;
the shutter section is a ceiling shutter provided at the ceiling opening; and
the method further comprises permitting an opening/closing operation of the ceiling shutter in a case in which a parking position has been selected as a shift range of a shift lever of the delivery vehicle.

14. The delivery vehicle control method of claim 13, further comprising preventing selection of a shift position other than the parking position as the shift range of the shift lever while an opening/closing operation of the ceiling shutter is in progress.

15. A non-transitory storage medium storing a program executable by a processor to perform delivery vehicle control processing in a delivery vehicle control system including a memory and the processor, which is coupled to the memory and installed in a delivery vehicle including:
a vehicle body;
an opening that is provided at the vehicle body, that is configured to be opened and closed by a shutter section, and that is configured to place a cabin interior and a cabin exterior in communication with each other;
a housing area that is provided at the cabin interior and that is configured to house a package;
a rail that is provided at the cabin interior; and
a transfer unit that is configured to move along the rail and that is configured to transfer the package between the housing area and the opening,
the delivery vehicle control processing comprising:
detecting a state of the cabin interior and an open/closed state of the shutter section, and causing the transfer unit to perform a transfer operation for the package in a case in which the cabin interior has been detected to be free of any occupant and the shutter section has been detected to be in a closed state; or
detecting an open/closed state of the shutter section, and causing the transfer unit to move to a retracted position separated from the opening in a case in which the shutter section has been detected to be in an open state.

16. The non-transitory storage medium of claim 15, wherein the delivery vehicle control processing further comprises causing the transfer unit to move to the retracted position separated from the opening in a case in which the shutter section has been detected to be in an open state.

17. The non-transitory storage medium of claim 15, wherein the delivery vehicle control processing further comprises:
confirming cooperation readiness between the delivery vehicle and a moving body configured to move externally to the delivery vehicle and to transport the package; and
causing the transfer unit to perform a transfer operation for the package, even when the shutter section has been detected to be in an open state, in a case in which the cooperation readiness between the delivery vehicle and the moving body has been confirmed.

18. The non-transitory storage medium of claim 17, wherein the delivery vehicle control processing further comprises:
detecting whether or not an object is present within a predetermined peripheral range of the moving body; and
effecting control such that transfer of the package is not performed by the transfer unit in a case in which the presence of an object has been detected within the predetermined peripheral range of the moving body.

19. The non-transitory storage medium of claim 15, wherein:
the opening is a ceiling opening provided at a vehicle roof section;
the shutter section is a ceiling shutter provided at the ceiling opening; and
the delivery vehicle control processing further comprises permitting an opening/closing operation of the ceiling shutter in a case in which a parking position has been selected as a shift range of a shift lever of the delivery vehicle.

20. The non-transitory storage medium of claim 19, wherein the delivery vehicle control processing further comprises preventing selection of a shift position other than the parking position as the shift range of the shift lever while an opening/closing operation of the ceiling shutter is in progress.
